(19) United States
(12) Patent Application Publication
(10) Pub. No.: US 2025/0185006 A1
(43) Pub. Date: Jun. 5, 2025

(54) TRANSMISSION AND RECEPTION DURING A RADIO RESOURCE MANAGEMENT MEASUREMENT PERIOD

(71) Applicant: Lenovo (Singapore) Pte. Limited, Singapore (SG)

(72) Inventors: Hossein Bagheri, Urbana, IL (US); Vijay Nangia, Woodridge, IL (US); Joachim Löhr, Wiesbaden (DE); Colin Frank, Park Ridge, IL (US)

(73) Assignee: Lenovo (Singapore) Pte. Limited, Singapore (SG)

(21) Appl. No.: 19/050,925

(22) Filed: Feb. 11, 2025

Related U.S. Application Data
(60) Provisional application No. 63/553,547, filed on Feb. 14, 2024.

(51) Int. Cl. H04W 72/1268; H04W 72/232; H04W 72/566

(52) U.S. Cl. CPC H04W 72/1268; H04W 72/232; H04W 72/566

(57) ABSTRACT

Various aspects of the present disclosure relate to transmission and reception during a radio resource management measurement period. A user equipment (UE) can be configured to have one or both of data transmission or reception (TX/RX) during a radio resource management (RRM) measurement period if a downlink control information (DCI) schedules such TX/RX overlapping with the RRM measurement period. Accordingly, if the UE receives from a network equipment (NE) a DCI scheduling data TX/RX that overlaps with a RRM measurement period in the time domain, the UE interprets the DCI as an indication from the NE to not perform measurements in the RRM measurement period, and to perform the scheduled TX/RX during the RRM measurement period.

### RELATED APPLICATION

This application claims priority to U.S. Patent Application Ser. No. 63/553,547 filed Feb. 14, 2024 entitled “TRANSMISSION AND RECEPTION DURING A RADIO RESOURCE MANAGEMENT MEASUREMENT PERIOD,” the disclosure of which is incorporated by reference herein in its entirety.

### TECHNICAL FIELD

The present disclosure relates to wireless communications, and more specifically to transmission and reception during a radio resource management (RRM) measurement period.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a configuration for a downlink control information (DCI) format, where the configuration indicates to prioritize data communication over radio resource management (RRM) measurement; receive a first DCI based at least in part on the DCI format, where the first DCI schedules a data transmission or a data reception, and where the data transmission or the data reception overlaps a first RRM measurement period; and transmit data or receive data based at least in part on the first DCI.

A processor (e.g., a standalone processor chipset, or a component of a UE) for wireless communication is described. The processor may be configured to, capable of, or operable to perform one or more operations as described herein. For example, the processor may be configured to, capable of, or operable to receive a configuration for a DCI format, where the configuration indicates for the processor to prioritize data communication over RRM measurement; receive a first DCI based at least in part on the DCI format, where the first DCI schedules a data transmission or a data reception, and where the data transmission or the data reception overlaps a first RRM measurement period; and transmit data or receive data based at least in part on the first DCI.

A method performed or performable by a UE for wireless communication is described. The method may include receiving a configuration for a DCI format, where the configuration indicates to prioritize data communication over RRM measurement; receiving a first DCI based at least in part on the DCI format, where the first DCI schedules a data transmission or a data reception, and where the data transmission or the data reception overlaps a first RRM measurement period; and transmitting data or receiving data based at least in part on the first DCI.

In some implementations of the UE, the processor, and the method described herein, the first RRM measurement period comprises an RRM measurement period for an inter-frequency measurement type.

In some implementations of the UE, the processor, and the method described herein, the first RRM measurement period comprises an RRM measurement period for an intra-frequency measurement type.

In some implementations of the UE, the processor, and the method described herein, the first DCI is received at least a threshold number of symbols prior to a start of the first RRM measurement period.

In some implementations of the UE, processor, and method described herein, the UE, processor, and method may further be configured to, capable of, performed, performable, or operable to transmit a configured transmission within the first RRM measurement period when the configured transmission starts at least a threshold number of symbols after an end of the first DCI and the configured transmission does not collide with the transmission of data to a NE based at least in part on the first DCI.

In some implementations of the UE, the processor, and the method described herein, the first DCI schedules an uplink (UL) transmission that overlaps the first RRM measurement period and the UE, processor, and method may further be configured to, capable of, performed, performable, or operable to receive an indication to cancel the scheduled UL transmission; and determine whether to perform the RRM measurement during the first RRM measurement period based at least in part on a time duration between an end of a signaling that includes the indication to cancel the scheduled UL transmission and a start of the measurement period.

In some implementations of the UE, processor, and method described herein, the UE, processor, and method may further be configured to, capable of, performed, performable, or operable to perform the RRM measurement during the first RRM measurement period if the time duration is larger than a threshold number of symbols.

In some implementations of the UE, processor, and method described herein, the UE is configured with the first RRM measurement period and a second RRM measurement period, the second RRM measurement period starts prior to the first RRM measurement period, the first RRM measurement period and the second RRM measurement period fully or partially overlap in a time domain, or a distance between the first RRM measurement period and the second RRM measurement period is less than a threshold amount of time, and the UE, processor, and method may further be configured to, capable of, performed, performable, or operable to perform the RRM measurements in the second RRM measurement period if a last symbol of the first DCI is received at least a threshold number of symbols prior to the second RRM measurement period.

In some implementations of the UE, processor, and method described herein, the UE is configured with the first RRM measurement period and a second RRM measurement period, the first RRM measurement period and the second RRM measurement period fully or partially overlap in a time domain, or a distance between the first RRM measurement period and the second RRM measurement period is less than a threshold amount of time, and the UE, processor, and method may further be configured to, capable of, performed, performable, or operable to resolve an overlap between the first RRM measurement period and the second RRM measurement period; and determine the first RRM measurement period based at least in part on the resolved overlap.

In some implementations of the UE, processor, and method described herein, to resolve the overlap between the first RRM measurement period and the second RRM measurement period, the UE, processor, and method may further be configured to, capable of, performed, performable, or operable to choose one of the first RRM measurement period and the second RRM measurement period.

In some implementations of the UE, the processor, and the method described herein, where the second RRM measurement period has a lower priority than the first RRM measurement period.

In some implementations of the UE, the processor, and the method described herein, the first RRM measurement period is one of multiple RRM measurement periods within a time duration, where no more than a configured number of the multiple RRM measurement periods in the time duration can be skipped and the UE, processor, and method may further be configured to, capable of, performed, performable, or operable to not perform the RRM measurement during the first RRM measurement period.

In some implementations of the UE, processor, and method described herein, the UE, processor, and method may further be configured to, capable of, performed, performable, or operable to receive a second DCI based at least in part on a group-common DCI format, and where the second DCI indicates, for each of the first RRM measurement period and a second RRM measurement period, whether to perform the RRM measurement during the RRM measurement period.

In some implementations of the UE, processor, and method described herein, the second DCI is received after the first DCI is received, the second DCI is applicable to the first RRM measurement period, and the second DCI indicates that the RRM measurements are to be skipped for the first RRM measurement period and that data is to be transmitted to or received from a NE during the first RRM measurement period.

An NE (e.g., a base station) for wireless communication is described. The NE may be configured to, capable of, or operable to perform one or more operations as described herein. For example, the NE may be configured to, capable of, or operable to transmit a configuration for a DCI format, where the configuration indicates for a UE to prioritize data communication over RRM measurement during RRM measurement periods when the data communication is scheduled to overlap in time with one of the RRM measurement periods; transmit a first DCI based at least in part on the DCI format, where the first DCI schedules a data transmission or a data reception, and where the data transmission or the data reception overlaps a RRM measurement period; and transmit data or receive data based at least in part on the first DCI.

A processor (e.g., a standalone processor chipset, or a component of a NE (e.g., a base station)) for wireless communication is described. The processor may be configured to, capable of, or operable to perform one or more operations as described herein. For example, the processor may be configured to, capable of, or operable to transmit a configuration for a DCI format, where the configuration indicates for a UE to prioritize data communication over RRM measurement during RRM measurement periods when the data communication is scheduled to overlap in time with one of the RRM measurement periods; transmit a first DCI based at least in part on the DCI format, where the first DCI schedules a data transmission or a data reception, and where the data transmission or the data reception overlaps a RRM measurement period; and transmit data or receive data based at least in part on the first DCI.

A method performed or performable by an NE (e.g., a base station) for wireless communication is described. The method may include transmitting a configuration for a DCI format, where the configuration indicates for a UE to prioritize data communication over RRM measurement during RRM measurement periods when the data communication is scheduled to overlap in time with one of the RRM measurement periods; transmitting a first DCI based at least in part on the DCI format, where the first DCI schedules a data transmission or a data reception, and where the data transmission or the data reception overlaps a RRM measurement period; and transmitting data or receiving data based at least in part on the first DCI.

In some implementations of the NE, the processor, and the method described herein, the first RRM measurement period comprises an RRM measurement period for an inter-frequency measurement type.

In some implementations of the NE, the processor, and the method described herein, the first RRM measurement period comprises an RRM measurement period for an intra-frequency measurement type.

In some implementations of the NE, the processor, and the method described herein, the first DCI is sent at least a threshold number of symbols prior to a start of the first RRM measurement period.

In some implementations of the NE, processor, and method described herein, the NE, processor, and method may further be configured to, capable of, performed, performable, or operable to receive a configured transmission within the first RRM measurement period when the configured transmission starts at least a threshold number of symbols after an end of the first DCI and the configured transmission does not collide with the transmission of data from the UE based at least in part on the first DCI.

In some implementations of the NE, processor, and method described herein, the first DCI schedules an UL transmission that overlaps the first RRM measurement period and the NE, processor, and method may further be configured to, capable of, performed, performable, or operable to transmit an indication to cancel the scheduled UL transmission.

In some implementations of the NE, the processor, and the method described herein, the first RRM measurement period is one of multiple RRM measurement periods within a time duration, and no more than a configured number of the multiple RRM measurement periods in the time duration can be skipped.

In some implementations of the NE, processor, and method described herein, the NE, processor, and method may further be configured to, capable of, performed, performable, or operable to transmit a second DCI based at least in part on a group-common DCI format, and the second DCI indicates, for each of the first RRM measurement period and a second RRM measurement period, whether to perform the RRM measurement during the RRM measurement period.

In some implementations of the NE, the processor, and the method described herein, the second DCI is transmitted after the first DCI is transmitted, the second DCI is applicable to the first RRM measurement period, and the second DCI indicates that the RRM measurements are to be skipped for the first RRM measurement period and that data is to be transmitted to or received from the UE during the first RRM measurement period.

### BRIEF DESCRIPTION OF THE DRAWINGS

FIG. 1 illustrates an example of a wireless communications system in accordance with aspects of the present disclosure.

FIG. 2 illustrates an example of scheduling DCI overlapping with a measurement period in accordance with aspects of the present disclosure.

FIG. 3 illustrates an example of configured grant (CG) transmission during a RRM measurement period in accordance with aspects of the present disclosure.

FIG. 4 illustrates an example of multiple DCIs for a measurement period in accordance with aspects of the present disclosure.

FIG. 5 illustrates an example of a group-common DCI (GC-DCI) in accordance with aspects of the present disclosure.

FIG. 6 illustrates an example of not excessively removing scheduling restrictions in accordance with aspects of the present disclosure.

FIG. 7 illustrates an example of canceling a scheduled UL transmission in accordance with aspects of the present disclosure.

FIG. 8 illustrates an example of two colliding measurement periods in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of a NE in accordance with aspects of the present disclosure.

FIG. 12 illustrates a flowchart of a method performed by a UE in accordance with aspects of the present disclosure.

FIG. 13 illustrates a flowchart of a method performed by a NE in accordance with aspects of the present disclosure.

### DETAILED DESCRIPTION

A cell typically has a base station providing a coverage area, which is a geographic area in which the cell provides wireless connectivity to devices within. A UE establishes a wireless connection with a cell, and subsequently that cell may be referred to as a serving cell of the UE. The UE can perform any one or more of various measurements, such as on received reference signals, that can be used to determine whether the UE is to switch to a different cell. The UE performs these measurements during time ranges or gaps referred to as RRM measurement periods, which may also be referred to as measurement periods or measurement gaps. In conventional systems, certain scheduling restrictions are applicable, which prevent the UE from transmitting or receiving data during the RRM measurement periods.

These restrictions on transmitting or receiving data during RRM measurement periods can degrade the system throughput of the wireless communications system (e.g., depending on the periodicity and lengths of the RRM measurement periods). For example, some UEs can be used for extended reality (XR) applications, which can include at least one of augmented reality (AR) applications, virtual reality (VR) applications, or mixed reality (MR) applications. In the case of XR data traffic, a set of packet data units (PDUs) are given a particular amount of time in which they are to be transferred between two devices (e.g., between the UE and the base station), referred to as a PDU-set delay budget. Preventing such data traffic from being transmitted or received during the RRM measurement periods can cause some PDU sets to be dropped due to the PDU-set delay budget not being satisfied.

Using the techniques discussed herein, a UE can be configured to have one or both of data transmission or reception (TX/RX) during a RRM measurement period if a DCI schedules such TX/RX overlapping with the RRM measurement period. Accordingly, if the UE receives from a NE a DCI scheduling data TX/RX that overlaps with a RRM measurement period in the time domain, the UE interprets the DCI as an indication from the NE to not perform measurements in the RRM measurement period, and/or to perform the scheduled TX/RX during the RRM measurement period. Not performing measurements in the RRM management period is also referred to as skipping or dropping the RRM measurement period. Not performing measurements in the RRM measurement period (e.g., so that data TX/RX can be performed during the RRM measurement period) is also referred to as disabling or skipping scheduling restrictions for the RRM measurement period.

In one or more implementations, two RRM measurement periods can collide. Two RRM measurement periods are referred to as colliding if the two RRM measurement periods are fully or partially overlapping in the time domain, or the distance between the two RRM measurement periods is equal to or less than 4 milliseconds (ms). In situations where there are two colliding RRM measurement periods, if a first of the two RRM measurement periods is indicated to be used for TX/RX (e.g., the UE receives a DCI scheduling TX/RX during the RRM measurement period), a second of the two RRM measurement periods (which may occur in time before or after the first of the two RRM measurement periods) can be used for performing one or more RRM measurements. However, the second of the two RRM measurement periods may be skipped if the DCI indication for TX/RX during the first of the two RRM measurement periods is received less than a threshold amount of time earlier than the earliest of the two colliding RRM measurement periods.

Using the techniques discussed herein, a NE can signal a UE to perform transmission or reception of data during a RRM measurement period rather than performing RRM measurements. This improves throughput of the wireless communications system due to data not being prevented from being transmitted during certain RRM measurement periods.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

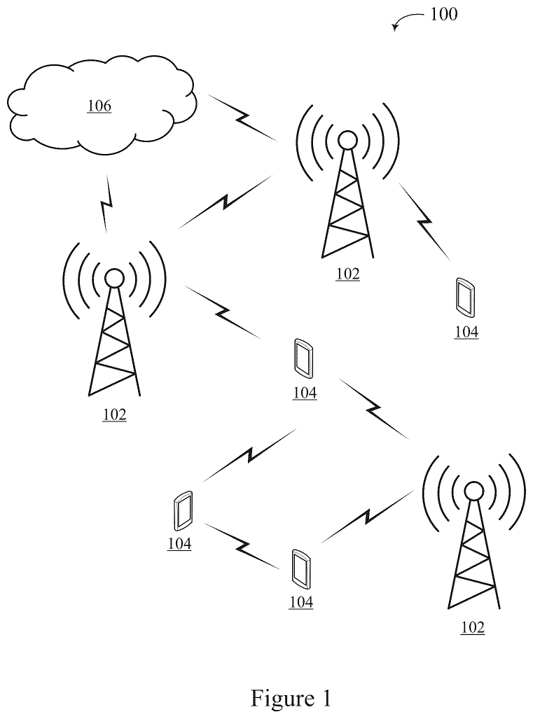

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., y=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some cases, a cell refers to a radio access node in communication with a base station or including a base station. A cell typically has a coverage area, which is a geographic area in which the cell provides wireless connectivity to devices within. Different cells may operate on defined frequencies or frequency bands, referred to as subcarriers. In some examples, a UE 104 establishes a wireless connection with a cell, and subsequently that cell may be referred to as a serving cell of the UE 104.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

In one or more implementations, a NE 102 can configure a UE 104 (e.g., using DCI) to perform one or both of data transmission or reception during a RRM measurement period by scheduling such transmission or reception overlapping with the RRM measurement period. Accordingly, if the UE 104 receives from the NE 102 a DCI scheduling data transmission or reception that overlaps with a RRM measurement period in the time domain, the UE 104 interprets the DCI as an indication from the NE 102 to not perform measurements in the RRM measurement period, and to perform the scheduled data transmission or reception during the RRM measurement period.

Using the techniques discussed herein, based on configuration per DCI format, a UE 104 can be configured to have TX/RX during a measurement period if a DCI schedules such TX/RX overlapping with the period. Additionally or alternatively, a GC-DCI can indicate (e.g., per group of RRM measurement periods) whether TX/RX during an upcoming RRM measurement period is possible. Additionally or alternatively, in case of two colliding RRM measurement periods, if one of the RRM measurement periods is indicated to be used for TX/RX, the other RRM measurement period is not dropped at least if the DCI indication is sent at least a certain time earlier than the earliest of the two colliding RRM measurement periods.

During measurement periods of specific measurement types (e.g., intra-frequency RRM measurements (FR2), or measurement gaps), conventional systems apply certain scheduling restrictions, which could degrade the system throughput (e.g., depending on the periodicity and length of the measurement gap). In case of XR traffic, the number of satisfied UEs (UEs with most of their PDU sets being delivered within the PDU-Set Delay Budget) may drop significantly (e.g., to more than 50% for some measurement configurations) due to scheduling restrictions during measurement periods.

DCI signaling can be used to de-activate or skip the scheduling restrictions during a next measurement period, hence, improving the number of satisfied UEs in case of XR traffic. The techniques discussed herein describe such DCI signaling, including UE-specific and group-common DCI formats along with their content, timeline, and configuration aspects. In addition, the techniques discussed herein provide new measurement period collision handling rules when a DCI de-activates scheduling restrictions in one of the colliding measurement periods.

Using conventional solutions, during the per-UE measurement periods the UE is not required to conduct reception/transmission from/to the corresponding NR serving cells for standalone (SA), with single carrier or carrier aggregation (CA) configured, except for the reception of signals used for one or more RRM measurements, one or more positioning reference signal (PRS) measurements, and the signals used for random access procedure.

Using conventional solutions, the following scheduling restriction apply due to layer 1 reference signal received power (L1-RSRP) measurement. In non-high-speed train (non-HST) scenario, for FR2-1 or the reference symbols to be measured for L1-RSRP is not using 480 kHz subcarrier spacing (SCS) or 960 kHz SCS on FR2-2, the UE is not expected to transmit physical uplink control channel (PUCCH), physical uplink shared channel (PUSCH), or sounding reference signal (SRS), or receive physical downlink control channel (PDCCH), physical downlink shared channel (PDSCH), or channel state information reference signal (CSI-RS) for tracking or CSI-RS for channel quality information (CQI) on symbols corresponding to the synchronization signal block (SSB) indexes configured for L1-RSRP measurement, and/or symbols corresponding to the periodic CSI-RS resource configured for L1-RSRP measurement, and/or symbols corresponding to the semi-persistent CSI-RS resource configured for L1-RSRP measurement when the resource is activated, and/or symbols corresponding to the aperiodic CSI-RS resource configured for L1-RSRP measurement when the reporting is triggered.

When a UE 104 is configured with concurrent measurement periods, two measurement periods (also referred to as measurement period occasions) are considered colliding if at least one of the following conditions is met: the two measurement periods are fully or partially overlapping in time domain, or the distance between the two measurement periods is equal to or smaller than 4 ms. The distance between two measurement periods is defined as the time difference between the ending point of the first measurement period and the starting point of the second measurement period, where the first measurement period occurs earlier in time than the second measurement period.

In case of collision between two measurement periods, the UE 104 performs measurements in the occasion of the measurement gap with higher priority, and the occasion of the measurement gap with lower priority is dropped. The UE 104 is able to transmit PUCCH/PUSCH/SRS or receive PDCCH/PDSCH/tracking reference signal (TRS)/CSI-RS for CQI in the corresponding NR serving cells in the slots that are not interrupted.

In the discussions herein, skipping or deactivating scheduling restrictions is also referred to as skipping RRM measurements. Skipping or dropping an RRM measurement period refers to not performing measurements in the RRM management period.

If the network has downlink (DL) data or DL acknowledgment (ACK) or negative acknowledgment (NACK) to schedule or is aware of UL data to be scheduled during a measurement period, the scheduling DCI can be sufficient to enable such TX/RX operation within a measurement period. The UE 104 can be configured to have TX/RX during a measurement period if a DCI (on or for a particular serving cell) schedules such TX/RX overlapping with the period. For configured grant UL transmissions (such as UL pose transmissions), a DCI to skip the measurement period is still used. However, considering the DCI overhead for such a case, it may also be possible to have a DCI schedule one or more UL pose transmissions for those occasions (or at least the first occasion) overlapping with the measurement period.

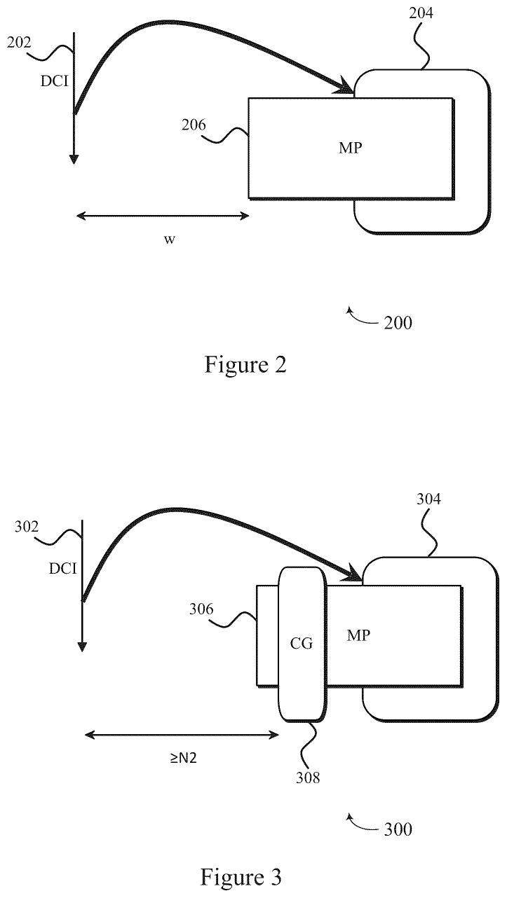

FIG. 2 illustrates an example of scheduling DCI overlapping with a measurement period in accordance with aspects of the present disclosure. In the example 200, time is along the horizontal axis. A DCI 202 is received that schedules a transmission or reception 204 that overlaps a measurement period (MP) 206 in the time domain. The measurement period 206 starts an amount of time w (e.g., a time duration or number of symbols) after receipt of the DCI 202.

The network can configure each DCI format or each pair of DCI formats (e.g., DCI formats x_1) separately as to whether they can indicate skipping of the RRM period or can be monitored for control channels or prioritized for data communication during a measurement period. For some DCI formats, such skipping may not be allowed, and hence, the UE 104 is not expected to be configured with such configurations (for instance, DCIs scheduling ultra-reliable low latency communications (URLLC) transmissions such as DCI formats x_2 may not be allowed to cause RRM measurement skipping). The configuration can be done per measurement type (such as inter-frequency measurement with measurement period or intra-frequency measurement for FR2). Intra-frequency measurements are concerned about monitoring signal quality of neighboring cells within the same band for potential handovers, whereas inter-frequency measurements are concerned about identifying and evaluating potential serving cells in different frequency bands for inter-band handovers.

Once a DCI (also referred to as a scheduling DCI) schedules a TX/RX within a measurement period, configured communications such as configured grant transmissions or semi persistent scheduling (SPS) receptions are also allowed in that measurement period. Such transmissions can be allowed from the beginning of the measurement period if the DCI has been sent at least a certain time (e.g., a threshold number of symbols, such as ‘N2’ symbols, where ‘N2’ is defined in 3rd Generation Partnership Project (3GPP) Technical specification (TS) 38.214 as a PUSCH preparation time that varies based on PUSCH timing capability of the UE and subcarrier spacing frequency) prior to the measurement period or such transmissions can be allowed from a threshold number of symbols (e.g., ‘N2’ symbols) from the end of the DCI transmission (subject to not colliding with the scheduled transmission).

FIG. 3 illustrates an example of CG transmission during a RRM measurement period in accordance with aspects of the present disclosure. The example 300 illustrates that CG transmission is allowed during a RRM measurement period if the CG transmission starts N2 symbols after the DCI. In the example 300, time is along the horizontal axis. A DCI 302 is received that schedules a transmission or reception 304 that overlaps a measurement period (MP) 306 in the time domain. A CG transmission 308 that starts at least a threshold number of symbols (e.g., N2) after the DCI 302 is allowed during the measurement period 306.

When data is not yet available for scheduling (e.g., due to jitter) but the base station expects to have some (e.g., XR) data to schedule before the end of a RRM measurement period, the base station can use a group-common DCI to indicate a RRM measurement period skipping (e.g., next measurement period that is at least a threshold number of symbols (e.g., ‘w’ symbols) after the end of the DCI). DCI format 2_0 or a new DCI format can be used for such an indication.

Although a GC-DCI can be applicable to all scenarios, both mechanisms above can be used as they can serve different scenarios. In particular, UE-specific DCI signaling described above saves unnecessary GC-DCI overhead in cases there is data available for scheduling.

For a given RRM measurement period, if a GC-DCI is sent earlier than a scheduling DCI, it is possible that the GC-DCI has not indicated measurement skipping in that RRM measurement period but the scheduling DCI implies the measurement skipping.

For a given RRM measurement period, if a GC-DCI is sent later than a scheduling DCI, the GC-DCI is expected to indicate measurement skipping in the period if the scheduling DCI implies the measurement skipping in that period.

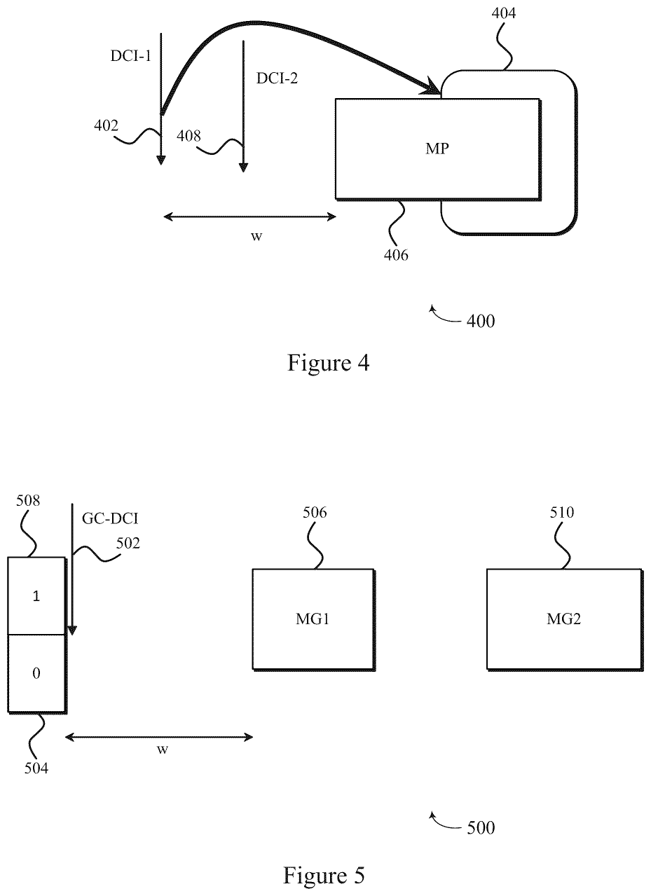

FIG. 4 illustrates an example of multiple DCIs for a measurement period in accordance with aspects of the present disclosure. In the example 400, time is along the horizontal axis. The example 400 illustrates that a first DCI 402 (DCI-1) schedules a transmission or reception 404 in an RRM measurement period 406, and a second DCI 408 (DCI-2) is a group-common DCI that is sent after the DCI-1 and is expected to indicate the scheduling restrictions for the RRM measurement period are skipped.

A MAC-CE or DCI indication can enable or disable scheduling restrictions in RRM measurement periods. In an example, a MAC-CE disables scheduling restriction in measurement periods of a group of measurement objects till another MAC-CE or a timer enables such restrictions again.

With respect to the content of the DCI, no special content is needed for the case of the scheduling DCI. For the GC-DCI, the UE can be configured with a location of a measurement skipping field in GC-DCI format. The location can be configured per serving cell for intra-frequency measurements and per band for inter-frequency measurement, per UE, per frequency range (FR), per configured measurement period pattern (e.g., in case of simultaneous configured measurement period patterns), or per measurement object or group of measurement objects.

FIG. 5 illustrates an example of a GC-DCI in accordance with aspects of the present disclosure. In the example 500, time is along the horizontal axis. The example 500 illustrates that a GC-DCI 502 has two fields: a field 504 (field 1) corresponding to a first measurement period 506 and a field 508 (field 2) corresponding to a second measurement period 510. One value (e.g., ‘0’) in a field of the GC-DCI 502 indicates scheduling restrictions for the corresponding measurement period are not skipped, and another value (e.g., ‘1’) in a field of the GC-DCI 502 indicates scheduling restrictions for the corresponding measurement period are skipped. Accordingly, in the example 500, the GC-DCI 502 indicates that scheduling restrictions for the measurement period 506 are not skipped and that scheduling restrictions for the measurement period 510 are skipped.

Both the scheduling DCI and the GC-DCI described above need to be sent at least a threshold amount of time (e.g., a few symbols to one slot) earlier than the beginning of the measurement period. This threshold amount of time can be at least one of reported by the UE in a capability reporting signaling, configured by the network, determined (e.g., reported or configured) per SCS (e.g., of the current and/or the target cell), or determined (e.g., reported or configured) per band.

In one or more implementations, to avoid frequent RRM measurement skipping the network may not send more than a threshold (e.g., ‘x’) number of commands to consecutively skip measurement periods (or ‘x’ commands within a determined or configured time duration). The value of ‘x’ can be configured or indicated to the UE, for example, via MAC-CE. Accordingly, the UE is not expected to receive more than ‘x’ DCI commands indicating consecutive skipping of RRM measurement periods. In one or more implementations, ‘x’ is indicated per RRM measurement type.

Additionally or alternatively, a prohibit timer is defined and the UE is not expecting to receive a DCI indicating skipping of scheduling restrictions in a measurement period until the timer expires.

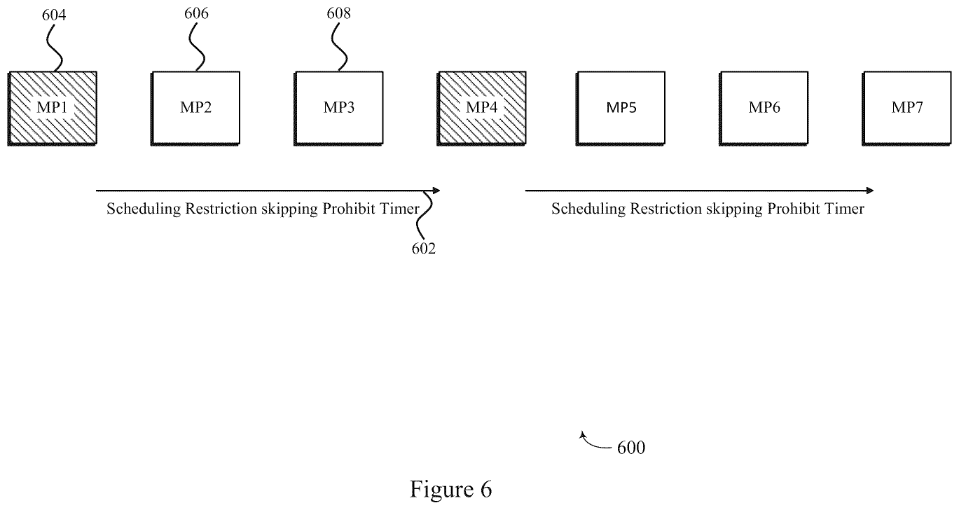

FIG. 6 illustrates an example of not excessively removing scheduling restrictions in accordance with aspects of the present disclosure. In the example 600, time is along the horizontal axis. The example 600 illustrates a prohibit timer 602 used to avoid excessively removing scheduling restrictions from RRM measurement periods. The prohibit timer 602 is set after a measurement period 604 is skipped (e.g., set at the beginning or the ending of the skipped measurement period). The UE is not expected to receive a DCI indicating skipping of measurement periods until the timer 602 expires. Accordingly, the UE is not expected to skip measurement periods 606 and 608.

If a scheduling DCI has scheduled an UL transmission within a RRM measurement period, and if the network has cancelled the scheduled transmission prior to a time offset (e.g., a threshold number of symbols) before the beginning of the RRM measurement period, the RRM measurement period is not considered skipped, and the UE performs the corresponding RRM measurements in that RRM measurement period.

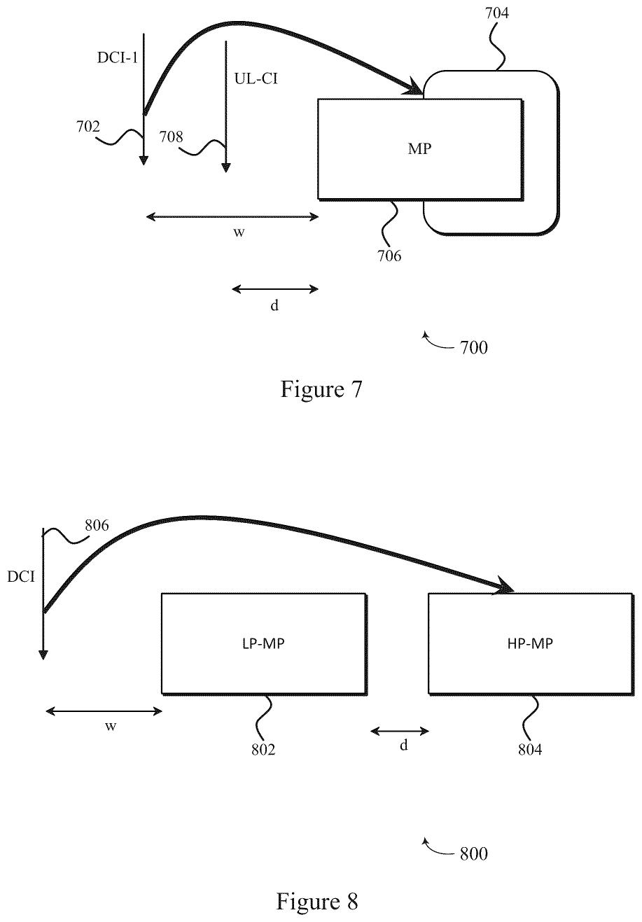

FIG. 7 illustrates an example of canceling a scheduled UL transmission in accordance with aspects of the present disclosure. In the example 700, time is along the horizontal axis. The example 700 illustrates that a DCI 702 (DCI-1) schedules a transmission 704 in an RRM measurement period 706. An UL cancellation (UL-CI) 708 cancels the UL transmission scheduled by the DCI 702 that overlaps with the RRM measurement period 706 a certain time (a threshold number of symbols ‘d’) prior to the RRM measurement period 706. In response, the UE is expected to perform RRM measurement in the RRM measurement period 706.

If two RRM measurement periods overlap (e.g., when intra-frequency SSB measurement timing configuration (SMTC) is partially overlapping with RRM measurement periods), transmission and reception are allowed during both RRM measurement periods. Additionally or alternatively, a RRM measurement period can have a lower priority than another RRM measurement period, and in case of overlap or collision amongst RRM measurement periods (including partial or full time overlap or when a distance between the two measurement periods is less than a threshold (e.g., 4 ms)), only one RRM measurement period is in effect. In such a scenario, the “next” measurement period is determined after resolving overlap amongst the RRM measurement periods. If a scheduling DCI schedules a transmission or reception in a first RRM measurement period of the two colliding measurement periods or if a GC-DCI indicates RRM skipping of the first RRM measurement period, the UE does not need to resolve the overlap between the first and the second measurement periods as only the second measurement period is valid for the measurement. Such case is valid if the DCI has sent at least a threshold number (e.g., ‘w’) symbols (for DCI processing) prior to the earliest RRM measurement period.

FIG. 8 illustrates an example of two colliding measurement periods in accordance with aspects of the present disclosure. In the example 800, time is along the horizontal axis. The example 800 illustrates that two RRM measurement periods 802 and 804 are colliding since the distance between the two RRM measurement periods 802 and 804 (illustrated as ‘d’) is less than 4 ms. A DCI 806 schedules a transmission within the RRM measurement period 804 (a higher priority measurement period (HP-MP)) or a DCI 806 that is a GC-DCI indicates scheduling restrictions to be avoided within the HP-MP, if the DCI 806 is sent early enough (at least ‘w’ symbols) prior to the earliest colliding measurement period (which is RRM measurement period 802, a lower priority measurement period (LP-MP)). Accordingly, the UE does not drop the lower-priority MP (RRM measurement period 802).

Thus, using the techniques discussed herein, based on configuration per DCI format a UE can be configured to have TX/RX during a measurement period if a DCI schedules such TX/RX overlapping with the period. If UL-CI cancels the scheduled transmission at least a certain time prior to the measurement period, the UE performs RRM measurement in the measurement period.

Additionally or alternatively, a GC-DCI can indicate (e.g., per group of measurement objects) whether TX/RX during an upcoming measurement period is possible.

Additionally or alternatively, in case of two colliding RRM measurement periods, if one of the RRM measurement periods is indicated to be used for TX/RX, the other RRM measurement period is not dropped at least if the DCI indication is sent at least a certain time earlier than the earliest of the two colliding RRM measurement periods.

Additionally or alternatively, a DCI indicating skipping of scheduling restrictions in a RRM measurement period is sent at least certain time (e.g., a slot) prior to the beginning of the RRM measurement period.

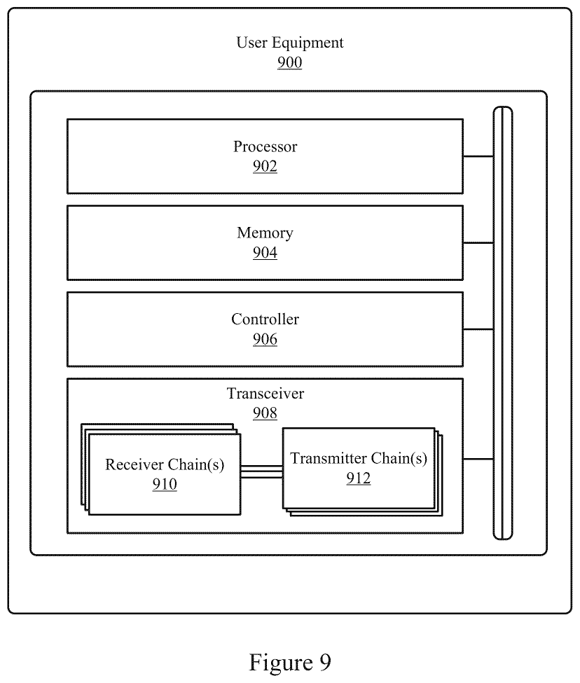

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving a configuration for a DCI format, where the configuration indicates to prioritize data communication over RRM measurement; receiving a first DCI based at least in part on the DCI format, where the first DCI schedules a data transmission or a data reception, and where the data transmission or the data reception overlaps a first RRM measurement period; and transmitting data or receiving data based at least in part on the DCI.

Additionally, the UE 900 may be configured to support any one or combination of where the first RRM measurement period comprises an RRM measurement period for an inter-frequency measurement type; where the first RRM measurement period comprises an RRM measurement period for an intra-frequency measurement type; where the first DCI is received at least a threshold number of symbols prior to a start of the first RRM measurement period; further including transmitting a configured transmission within the first RRM measurement period when the configured transmission starts at least a threshold number of symbols after an end of the first DCI and the configured transmission does not collide with the transmission of data to a NE based at least in part on the first DCI; where the first DCI schedules an UL transmission that overlaps the first RRM measurement period and further including receiving an indication to cancel the scheduled UL transmission; and determining whether to perform the RRM measurement during the first RRM measurement period based at least in part on a time duration between an end of a signaling that includes the indication to cancel the scheduled UL transmission and a start of the measurement period; further including performing the RRM measurement during the first RRM measurement period if the time duration is larger than a threshold number of symbols; where the UE is configured with the first RRM measurement period and a second RRM measurement period, where the second RRM measurement period starts prior to the first RRM measurement period, where the first RRM measurement period and the second RRM measurement period fully or partially overlap in a time domain, or a distance between the first RRM measurement period and the second RRM measurement period is less than a threshold amount of time, and further including performing the RRM measurements in the second RRM measurement period if a last symbol of the first DCI is received at least a threshold number of symbols prior to the second RRM measurement period; where the UE is configured with the first RRM measurement period and a second RRM measurement period, where the first RRM measurement period and the second RRM measurement period fully or partially overlap in a time domain, or a distance between the first RRM measurement period and the second RRM measurement period is less than a threshold amount of time, and further including resolving an overlap between the first RRM measurement period and the second RRM measurement period; and determining the first RRM measurement period based at least in part on the resolved overlap; where resolving the overlap between the first RRM measurement period and the second RRM measurement period includes choosing one of the first RRM measurement period and the second RRM measurement period; where the second RRM measurement period has a lower priority than the first RRM measurement period; where the first RRM measurement period is one of multiple RRM measurement periods within a time duration, where no more than a configured number of the multiple RRM measurement periods in the time duration can be skipped and further including not performing the RRM measurement during the first RRM measurement period; further including receiving a second DCI based at least in part on a group-common DCI format, and where the second DCI indicates, for each of the first RRM measurement period and a second RRM measurement period, whether to perform the RRM measurement during the RRM measurement period; where the second DCI is received after the first DCI is received, the second DCI is applicable to the first RRM measurement period, and the second DCI indicates that the RRM measurements are to be skipped for the first RRM measurement period and that data is to be transmitted to or received from a NE during the first RRM measurement period.

Additionally, or alternatively, the UE 900 may support at least one memory (e.g., the memory 904) and at least one processor (e.g., the processor 902) coupled with the at least one memory and configured to cause the UE to: receive, a configuration for a DCI format, where the configuration indicates to prioritize data communication over RRM measurement; receive a first DCI based at least in part on the DCI format, where the first DCI schedules a data transmission or a data reception, and where the data transmission or the data reception overlaps a first RRM measurement period; and transmit data or receive data based at least in part on the first DCI.

Additionally, the UE 900 may be configured to support any one or combination of where the first RRM measurement period comprises an RRM measurement period for an inter-frequency measurement type; where the first RRM measurement period comprises an RRM measurement period for an intra-frequency measurement type; where the first DCI is received at least a threshold number of symbols prior to a start of the first RRM measurement period; transmit a configured transmission within the first RRM measurement period when the configured transmission starts at least a threshold number of symbols after an end of the first DCI and the configured transmission does not collide with the transmission of data to a NE based at least in part on the first DCI; where the first DCI schedules an UL transmission that overlaps the first RRM measurement period and the at least one processor is further configured to cause the UE to receive an indication to cancel the scheduled UL transmission; and determine whether to perform the RRM measurement during the first RRM measurement period based at least in part on a time duration between an end of a signaling that includes the indication to cancel the scheduled UL transmission and a start of the measurement period; the at least one processor is further configured to cause the UE to perform the RRM measurement during the first RRM measurement period if the time duration is larger than a threshold number of symbols; where the UE is configured with the first RRM measurement period and a second RRM measurement period, where the second RRM measurement period starts prior to the first RRM measurement period, where the first RRM measurement period and the second RRM measurement period fully or partially overlap in a time domain, or a distance between the first RRM measurement period and the second RRM measurement period is less than a threshold amount of time, and the at least one processor is further configured to cause the UE to perform the RRM measurements in the second RRM measurement period if a last symbol of the first DCI is received at least a threshold number of symbols prior to the second RRM measurement period; the UE is configured with the first RRM measurement period and a second RRM measurement period, where the first RRM measurement period and the second RRM measurement period fully or partially overlap in a time domain, or a distance between the first RRM measurement period and the second RRM measurement period is less than a threshold amount of time, and where the at least one processor is further configured to cause the UE to resolve an overlap between the first RRM measurement period and the second RRM measurement period; and determine the first RRM measurement period based at least in part on the resolved overlap; where, to resolve the overlap between the first RRM measurement period and the second RRM measurement period, the at least one processor is further configured to cause the UE to choose one of the first RRM measurement period and the second RRM measurement period; where the second RRM measurement period has a lower priority than the first RRM measurement period; where the first RRM measurement period is one of multiple RRM measurement periods within a time duration, where no more than a configured number of the multiple RRM measurement periods in the time duration can be skipped and the at least one processor is further configured to cause the UE to not perform the RRM measurement during the first RRM measurement period; the at least one processor is further configured to cause the UE to receive a second DCI based at least in part on a group-common DCI format, and where the second DCI indicates, for each of the first RRM measurement period and a second RRM measurement period, whether to perform the RRM measurement during the RRM measurement period; where the second DCI is received after the first DCI is received, the second DCI is applicable to the first RRM measurement period, and the second DCI indicates that the RRM measurements are to be skipped for the first RRM measurement period and that data is to be transmitted to or received from a NE during the first RRM measurement period.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

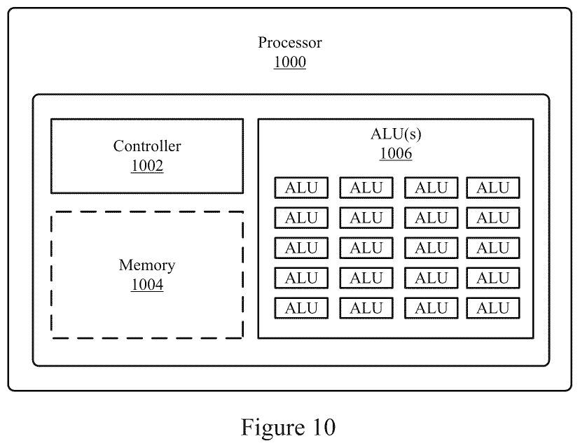

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to: receive a configuration for a DCI format, where the configuration indicates for the processor to prioritize data communication over RRM measurement; receive a first DCI based at least in part on the DCI format, where the first DCI schedules a data transmission or a data reception, and where the data transmission or the data reception overlaps a first RRM measurement period; and transmit data or receive data based at least in part on the first DCI.

Additionally, the processor 1000 may be configured to or operable to support any one or combination of where the first RRM measurement period comprises an RRM measurement period for an inter-frequency measurement type; where the first RRM measurement period comprises an RRM measurement period for an intra-frequency measurement type; where the first DCI is received at least a threshold number of symbols prior to a start of the first RRM measurement period; the at least one controller is further configured to cause the processor to transmit a configured transmission within the first RRM measurement period when the configured transmission starts at least a threshold number of symbols after an end of the first DCI and the configured transmission does not collide with the transmission of data to a NE based at least in part on the first DCI; where the first DCI schedules an UL transmission that overlaps the first RRM measurement period and the at least one controller is further configured to cause the processor to receive an indication to cancel the scheduled UL transmission; and determine whether to perform the RRM measurement during the first RRM measurement period based at least in part on a time duration between an end of a signaling that includes the indication to cancel the scheduled UL transmission and a start of the measurement period; the at least one controller is further configured to cause the processor to perform the RRM measurement during the first RRM measurement period if the time duration is larger than a threshold number of symbols; where a UE that includes the processor is configured with the first RRM measurement period and a second RRM measurement period, where the second RRM measurement period starts prior to the first RRM measurement period, where the first RRM measurement period and the second RRM measurement period fully or partially overlap in a time domain, or a distance between the first RRM measurement period and the second RRM measurement period is less than a threshold amount of time, and the at least one controller is further configured to cause the processor to perform the RRM measurements in the second RRM measurement period if a last symbol of the first DCI is received at least a threshold number of symbols prior to the second RRM measurement period; where a UE that includes the processor is configured with the first RRM measurement period and a second RRM measurement period, where the first RRM measurement period and the second RRM measurement period fully or partially overlap in a time domain, or a distance between the first RRM measurement period and the second RRM measurement period is less than a threshold amount of time, and the at least one controller is further configured to cause the processor to resolve an overlap between the first RRM measurement period and the second RRM measurement period; and determine the first RRM measurement period based at least in part on the resolved overlap; where to resolve the overlap between the first RRM measurement period and the second RRM measurement period, the at least one controller is further configured to cause the processor to choose one of the first RRM measurement period and the second RRM measurement period; where the second RRM measurement period has a lower priority than the first RRM measurement period; where the first RRM measurement period is one of multiple RRM measurement periods within a time duration, where no more than a configured number of the multiple RRM measurement periods in the time duration can be skipped and the at least one controller is further configured to cause the processor to not perform the RRM measurement during the first RRM measurement period; where the at least one controller is further configured to cause the processor to receive a second DCI based at least in part on a group-common DCI format, and where the second DCI indicates, for each of the first RRM measurement period and a second RRM measurement period, whether to perform the RRM measurement during the RRM measurement period; where the second DCI is received after the first DCI is received, the second DCI is applicable to the first RRM measurement period, and the second DCI indicates that the RRM measurements are to be skipped for the first RRM measurement period and that data is to be transmitted to or received from the NE during the first RRM measurement period.

Additionally, the processor 1000 may be configured to or operable to support at least one controller (e.g., the controller 1002) coupled with at least one memory (e.g., the memory 1004) and configured to cause the processor to: transmit a configuration for a DCI format, where the configuration indicates for a UE to prioritize data communication over RRM measurement during RRM measurement periods when the data communication is scheduled to overlap in time with one of the RRM measurement periods; transmit a first DCI based at least in part on the DCI format, where the first DCI schedules a data transmission or a data reception, and where the data transmission or the data reception overlaps a RRM measurement period; and transmit data or receive data based at least in part on the first DCI.

Additionally, the processor 1000 may be configured to or operable to support any one or combination of where the first RRM measurement period comprises an RRM measurement period for an inter-frequency measurement type; where the first RRM measurement period comprises an RRM measurement period for an intra-frequency measurement type; where the first DCI is sent at least a threshold number of symbols prior to a start of the first RRM measurement period; the at least one processor is further configured to cause the NE to receive a configured transmission within the first RRM measurement period when the configured transmission starts at least a threshold number of symbols after an end of the first DCI and the configured transmission does not collide with the transmission of data from the UE based at least in part on the first DCI; where the first DCI schedules an UL transmission that overlaps the first RRM measurement period and the at least one processor is further configured to cause the NE to transmit an indication to cancel the scheduled UL transmission; where the first RRM measurement period is one of multiple RRM measurement periods within a time duration, and where no more than a configured number of the multiple RRM measurement periods in the time duration can be skipped; the at least one processor is further configured to cause the NE to transmit a second DCI based at least in part on a group-common DCI format, and where the second DCI indicates, for each of the first RRM measurement period and a second RRM measurement period, whether to perform the RRM measurement during the RRM measurement period; where the second DCI is transmitted after the first DCI is transmitted, the second DCI is applicable to the first RRM measurement period, and the second DCI indicates that the RRM measurements are to be skipped for the first RRM measurement period and that data is to be transmitted to or received from the UE during the first RRM measurement period.

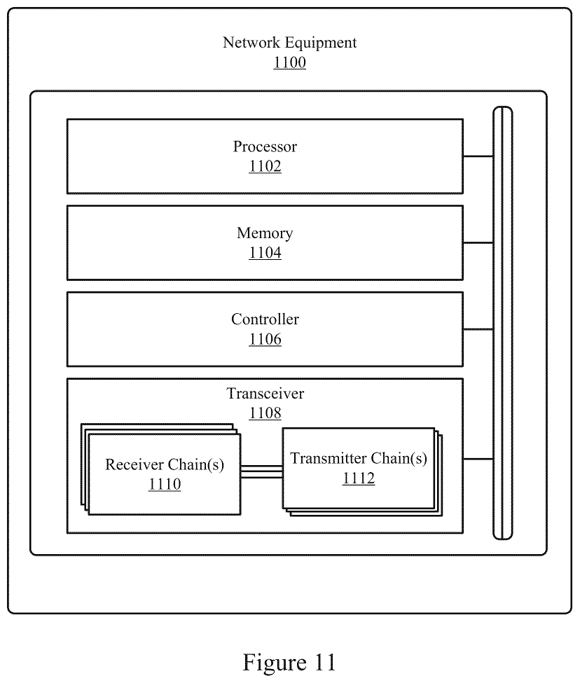

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to support a means for transmitting a configuration for a DCI format, where the configuration indicates for a UE to prioritize data communication over RRM measurement; transmitting a first DCI based at least in part on the DCI format, where the first DCI schedules a data transmission or a data reception, and where the data transmission or the data reception overlaps a RRM measurement period; and transmitting data or receiving data based at least in part on the first DCI.

Additionally, the NE 1100 may be configured to support any one or combination of where the first RRM measurement period comprises an RRM measurement period for an inter-frequency measurement type; where the first RRM measurement period comprises an RRM measurement period for an intra-frequency measurement type; where the first DCI is sent at least a threshold number of symbols prior to a start of the first RRM measurement period; receiving a configured transmission within the first RRM measurement period when the configured transmission starts at least a threshold number of symbols after an end of the first DCI and the configured transmission does not collide with the transmission of data from the UE based at least in part on the first DCI; where the first DCI schedules an UL transmission that overlaps the first RRM measurement period and further including transmitting an indication to cancel the scheduled UL transmission; where the first RRM measurement period is one of multiple RRM measurement periods within a time duration, and where no more than a configured number of the multiple RRM measurement periods in the time duration can be skipped; transmitting a second DCI based at least in part on a group-common DCI format, and where the second DCI indicates, for each of the first RRM measurement period and a second RRM measurement period, whether to perform the RRM measurement during the RRM measurement period; where the second DCI is transmitted after the first DCI is transmitted, the second DCI is applicable to the first RRM measurement period, and the second DCI indicates that the RRM measurements are to be skipped for the first RRM measurement period and that data is to be transmitted to or received from the UE during the first RRM measurement period.

Additionally, or alternatively, the NE 1100 may support at least one memory (e.g., the memory 1104) and at least one processor (e.g., the processor 1102) coupled with the at least one memory and configured to cause the NE to: transmit a configuration for a DCI format, where the configuration indicates for a UE to prioritize data communication over RRM measurement; transmit a first DCI based at least in part on the DCI format, where the first DCI schedules a data transmission or a data reception, and where the data transmission or the data reception overlaps a RRM measurement period; and transmit data or receive data based at least in part on the first DCI.

Additionally, the NE 1100 may be configured to support any one or combination of where the first RRM measurement period comprises an RRM measurement period for an inter-frequency measurement type; where the first RRM measurement period comprises an RRM measurement period for an intra-frequency measurement type; where the first DCI is sent at least a threshold number of symbols prior to a start of the first RRM measurement period; the at least one processor is further configured to cause the NE to receive a configured transmission within the first RRM measurement period when the configured transmission starts at least a threshold number of symbols after an end of the first DCI and the configured transmission does not collide with the transmission of data from the UE based at least in part on the first DCI; where the first DCI schedules an UL transmission that overlaps the first RRM measurement period and the at least one processor is further configured to cause the NE to transmit an indication to cancel the scheduled UL transmission; where the first RRM measurement period is one of multiple RRM measurement periods within a time duration, and where no more than a configured number of the multiple RRM measurement periods in the time duration can be skipped; the at least one processor is further configured to cause the NE to transmit a second DCI based at least in part on a group-common DCI format, and where the second DCI indicates, for each of the first RRM measurement period and a second RRM measurement period, whether to perform the RRM measurement during the RRM measurement period; where the second DCI is transmitted after the first DCI is transmitted, the second DCI is applicable to the first RRM measurement period, and the second DCI indicates that the RRM measurements are to be skipped for the first RRM measurement period and that data is to be transmitted to or received from the UE during the first RRM measurement period.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

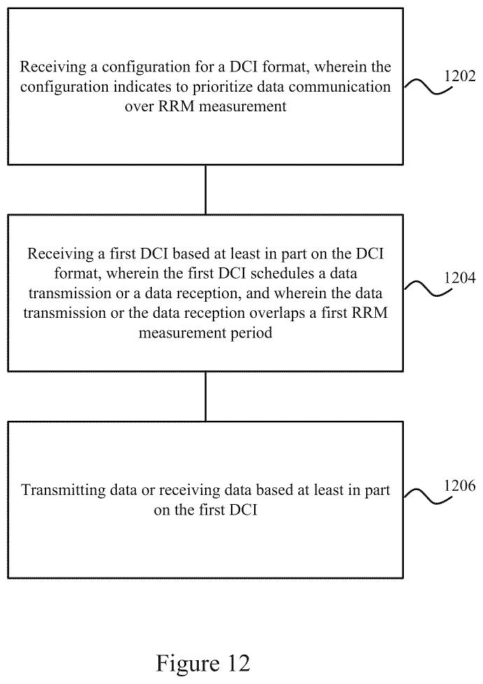

FIG. 12 illustrates a flowchart of a method in accordance with aspects of the present disclosure. The operations of the method may be implemented by a UE as described herein. In some implementations, the UE may execute a set of instructions to control the function elements of the UE to perform the described functions.

At 1202, the method may include receiving a configuration for a DCI format, wherein the configuration indicates to prioritize data communication over RRM measurement. The operations of 1202 may be performed in accordance with examples as described herein. In some implementations, aspects of the operations of 1202 may be performed by a UE as described with reference to FIG. 9.

At 1204, the method may include receiving a first DCI based at least in part on the DCI format, wherein the first DCI schedules a data transmission or a data reception, and wherein the data transmission or the data reception overlaps a first RRM measurement period. The operations of 1204 may be performed in accordance with examples as described herein. In some implementations, aspects of the operations of 1204 may be performed by a UE as described with reference to FIG. 9.

At 1206, the method may include transmitting data or receiving data based at least in part on the first DCI. The operations of 1206 may be performed in accordance with examples as described herein. In some implementations, aspects of the operations of 1206 may be performed a UE as described with reference to FIG. 9.

It should be noted that the method described herein describes a possible implementation, and that the operations and the steps may be rearranged or otherwise modified and that other implementations are possible.

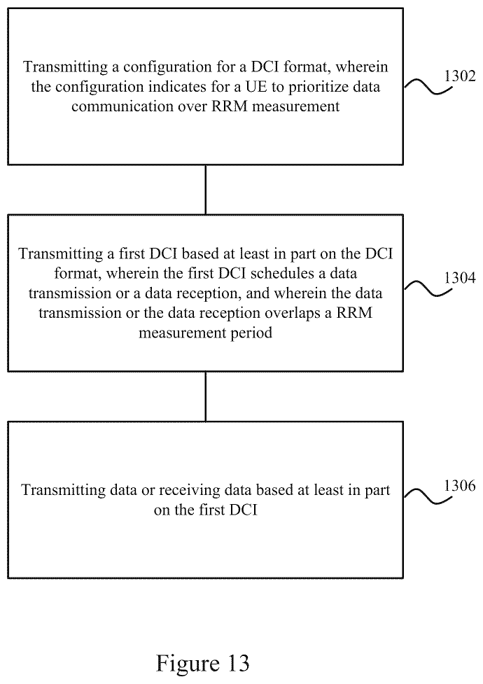

FIG. 13 illustrates a flowchart of a method in accordance with aspects of the present disclosure. The operations of the method may be implemented by a NE as described herein. In some implementations, the NE may execute a set of instructions to control the function elements of the NE to perform the described functions.

At 1302, the method may include transmitting a configuration for a DCI format, wherein the configuration indicates for a UE to prioritize data communication over RRM measurement. The operations of 1302 may be performed in accordance with examples as described herein. In some implementations, aspects of the operations of 1302 may be performed by a NE as described with reference to FIG. 11.

At 1304, the method may include transmitting a first DCI based at least in part on the DCI format, wherein the first DCI schedules a data transmission or a data reception, and wherein the data transmission or the data reception overlaps a RRM measurement period. The operations of 1304 may be performed in accordance with examples as described herein. In some implementations, aspects of the operations of 1304 may be performed by a NE as described with reference to FIG. 11.

At 1306, the method may include transmitting data to or receiving data based at least in part on the first DCI. The operations of 1306 may be performed in accordance with examples as described herein. In some implementations, aspects of the operations of 1306 may be performed a NE as described with reference to FIG. 11.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration for a downlink control information (DCI) format, wherein the configuration indicates to prioritize data communication over radio resource management (RRM) measurement;
receive a first DCI based at least in part on the DCI format, wherein the first DCI schedules a data transmission or a data reception, and wherein the data transmission or the data reception overlaps a first RRM measurement period; and
transmit data or receive data based at least in part on the first DCI.

2. The UE of claim 1, wherein the first RRM measurement period comprises an RRM measurement period for an inter-frequency measurement type or an RRM measurement period for an intra-frequency measurement type.

3. The UE of claim 1, wherein the first DCI is received at least a threshold number of symbols prior to a start of the first RRM measurement period.

4. The UE of claim 1, wherein the at least one processor is further configured to cause the UE to transmit a configured transmission within the first RRM measurement period when the configured transmission starts at least a threshold number of symbols after an end of the first DCI and the configured transmission does not collide with the transmission of data to a network equipment (NE) based at least in part on the first DCI.

5. The UE of claim 1, wherein the first DCI schedules an uplink (UL) transmission that overlaps the first RRM measurement period and wherein the at least one processor is further configured to cause the UE to:
receive an indication to cancel the scheduled UL transmission; and
determine whether to perform the RRM measurement during the first RRM measurement period based at least in part on a time duration between an end of a signaling that includes the indication to cancel the scheduled UL transmission and a start of the measurement period.

6. The UE of claim 5, wherein the at least one processor is further configured to cause the UE to perform the RRM measurement during the first RRM measurement period if the time duration is larger than a threshold number of symbols.

7. The UE of claim 1, wherein the UE is configured with the first RRM measurement period and a second RRM measurement period, wherein the second RRM measurement period starts prior to the first RRM measurement period, wherein the first RRM measurement period and the second RRM measurement period fully or partially overlap in a time domain, or a distance between the first RRM measurement period and the second RRM measurement period is less than a threshold amount of time, and wherein the at least one processor is further configured to cause the UE to:
perform the RRM measurements in the second RRM measurement period if a last symbol of the first DCI is received at least a threshold number of symbols prior to the second RRM measurement period.

8. The UE of claim 1, wherein the UE is configured with the first RRM measurement period and a second RRM measurement period, wherein the first RRM measurement period and the second RRM measurement period fully or partially overlap in a time domain, or a distance between the first RRM measurement period and the second RRM measurement period is less than a threshold amount of time, and wherein the at least one processor is further configured to cause the UE to:
resolve an overlap between the first RRM measurement period and the second RRM measurement period; and
determine the first RRM measurement period based at least in part on the resolved overlap.

9. The UE of claim 8, wherein, to resolve the overlap between the first RRM measurement period and the second RRM measurement period, the at least one processor is further configured to cause the UE to:
choose one of the first RRM measurement period and the second RRM measurement period.

10. The UE of claim 9, wherein the second RRM measurement period has a lower priority than the first RRM measurement period.

11. The UE of claim 1, wherein the first RRM measurement period is one of multiple RRM measurement periods within a time duration, wherein no more than a configured number of the multiple RRM measurement periods in the time duration can be skipped and wherein the at least one processor is further configured to cause the UE to:
not perform the RRM measurement during the first RRM measurement period.

12. The UE of claim 1, wherein the at least one processor is further configured to cause the UE to receive a second DCI based at least in part on a group-common DCI format, and wherein the second DCI indicates, for each of the first RRM measurement period and a second RRM measurement period, whether to perform the RRM measurement during the RRM measurement period.

13. The UE of claim 12, wherein the second DCI is received after the first DCI is received, the second DCI is applicable to the first RRM measurement period, and the second DCI indicates that the RRM measurements are to be skipped for the first RRM measurement period and that data is to be transmitted to or received from a network equipment (NE) during the first RRM measurement period.

14. A base station for wireless communication, comprising:
at least one memory; and
at least one processor coupled with the at least one memory and configured to cause the base station to:
transmit a configuration for a downlink control information (DCI) format, wherein the configuration indicates for a user equipment (UE) to prioritize data communication over radio resource management (RRM) measurement;
transmit a first DCI based at least in part on the DCI format, wherein the first DCI schedules a data transmission or a data reception, and wherein the data transmission or the data reception overlaps a RRM measurement period; and
transmit data or receive data based at least in part on the first DCI.

15. The base station of claim 14, wherein the first RRM measurement period comprises an RRM measurement period for an inter-frequency measurement type or an RRM measurement period for an intra-frequency measurement type.

16. The base station of claim 14, wherein the first DCI is sent at least a threshold number of symbols prior to a start of the first RRM measurement period.

17. The base station of claim 14, wherein the at least one processor is further configured to cause the base station to receive a configured transmission within the first RRM measurement period when the configured transmission starts at least a threshold number of symbols after an end of the first DCI and the configured transmission does not collide with the transmission of data from the UE based at least in part on the first DCI.

18. The base station of claim 14, wherein the first DCI schedules an uplink (UL) transmission that overlaps the first RRM measurement period and wherein the at least one processor is further configured to cause the base station to:
transmit an indication to cancel the scheduled UL transmission.

19. A method performed by a user equipment (UE), the method comprising:
receiving a configuration for a downlink control information (DCI) format, wherein the configuration indicates to prioritize data communication over radio resource management (RRM) measurement;
receiving a first DCI based at least in part on the DCI format, wherein the first DCI schedules a data transmission or a data reception, and wherein the data transmission or the data reception overlaps a first RRM measurement period; and
transmitting data or receiving data based at least in part on the first DCI.

20. A method performed by a base station, the method comprising:
transmitting a configuration for a downlink control information (DCI) format, wherein the configuration indicates for a user equipment (UE) to prioritize data communication over radio resource management (RRM) measurement;
transmitting a first DCI based at least in part on the DCI format, wherein the first DCI schedules a data transmission or a data reception, and wherein the data transmission or the data reception overlaps a RRM measurement period; and
transmitting data or receiving data based at least in part on the first DCI.
